(19) United States
(12) Patent Application Publication
(10) Pub. No.: US 2017/0219104 A1
(43) Pub. Date: Aug. 3, 2017

(54) THREE-WAY VALVE AND METHOD FOR USING THE SAME

(71) Applicant: Micron Technology, Inc., Boise, ID (US)

(72) Inventors: Yung-Po Lin, New Taipei City (TW); Chun-Wei Huang, Keelung City (TW)

(21) Appl. No.: 15/013,995

(22) Filed: Feb. 2, 2016

(51) Int. Cl. F16K 11/076

(52) U.S. Cl. CPC F16K 11/076

(57) ABSTRACT

A three-way valve includes a sample port acting as a dual port, a sensor port and a purge port. The purge port selectively provides the sample port with a purge gas when an etching chamber is idle and the sensor port is not in use.

### BACKGROUND OF THE INVENTION

1. Field of the Invention

The present invention generally relates to a three-way valve and use of a three-way valve. In particular, the present invention is directed to a three-way valve which is capable of purging a possible liquid in an exhaust pipe which is directly connected with the three-way valve without disturbing the function of a sensor port of the three-way valve and use of the three-way valve.

2. Description of the Prior Art

In a manufacturing process for semiconductor, a wet etching procedure is usually carried out on a wafer in an etching chamber. The wet etching procedure generates some waste so the disposal of the waste is through an exhaust line, such as an exhaust pipe. The exhaust pressure in the exhaust pipe is constantly monitored but there are always some liquids in the exhaust pipe.

Once there are some liquids accumulated in the exhaust pipe, the liquids are usually the cause of abnormal detection of the sensor to detect the pressure in the exhaust line. In that case, the abnormal detection activates the safety system to alarm and it increases the risk to scrap the wafers which are kept in the etching chamber.

### SUMMARY OF THE INVENTION

In the light of the above, the present invention proposes a three-way valve and the use of a three-way valve to reduce the risk to scrap the wafers kept in the etching chamber. The use of the novel three-way valve is able to reduce the risk of the liquid which tends to accumulate in the exhaust pipe to result in abnormal detection of the sensor so the safety system is less likely to be activated and the risk to scrap the wafers kept in the etching chamber can be greatly decreased.

The present invention in a first aspect proposes a three-way valve. The three-way valve of the present invention includes a valve joint, a sample port, a sensor port and a purge port. The sample port is directly connected to the valve joint and serves as a dual port. The sensor port is directly connected to the valve joint. The purge port is directly connected to the valve joint to selectively provide the sample port with a purge gas when the sensor port is not in use.

In one embodiment of the present invention, the three-way valve is an electro-magnetic valve.

In another embodiment of the present invention, the sample port is connected to an exhaust pipe including a wet etching reagent.

In another embodiment of the present invention, the sensor port is connected to a pressure sensor.

In another embodiment of the present invention, the sample port is an inlet when the pressure sensor is in use.

In another embodiment of the present invention, the sample port is an outlet of the purge gas when the purge port provides the purge gas.

In another embodiment of the present invention, the purge port is an inlet to provide the purge gas to purge the wet etching reagent in the exhaust pipe.

In another embodiment of the present invention, the three-way valve is controlled by an automation control system which is electrically connected to the pressure sensor.

In another embodiment of the present invention, the three-way valve is controlled manually.

In another embodiment of the present invention, the sensor port is disconnected when the purge port provides the sample port with a purge gas.

The present invention in a second aspect proposes the use of a three-way valve. First, a three-way valve is provided. The three-way valve includes a valve joint, a sample port, a sensor port and a purge port. The sample port is directly connected to the valve joint and serves as a dual port. The sensor port is directly connected to the valve joint. The purge port is directly connected to the valve joint to selectively provide the sample port with a purge gas when the sensor port is not in use. Second, the purge port is disconnected when the sample port and the sensor port are connected. Then, the sensor port is disconnected when the sample port and the purge port are connected for the purge port to provide the sample port with the purge gas.

In one embodiment of the present invention, the sample port is connected to an exhaust pipe including a wet etching reagent.

In another embodiment of the present invention, the sensor port is connected to a pressure sensor for the detection of the exhaust pipe when the sample port and the sensor port are connected.

In another embodiment of the present invention, the sample port serves as an inlet.

In another embodiment of the present invention, the sample port is an outlet of the purge gas when the purge port provides the purge gas.

In another embodiment of the present invention, the purge port is an inlet to provide the purge gas to purge the wet etching reagent in the exhaust pipe.

In another embodiment of the present invention, the three-way valve is controlled by an automation control system which is electrically connected to the pressure sensor.

In another embodiment of the present invention, the three-way valve is controlled manually.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first example of the three-way valve of the present invention.

FIG. 2 illustrates a second example of the three-way valve of the present invention.

FIG. 3 illustrates the three-way valve of the present invention further connected to an exhaust pipe.

FIG. 4 illustrates the three-way valve of the present invention further connected to an automation control system.

FIG. 5 illustrates the three-way valve of the present invention further connected to a purge gas source.

FIG. 6 illustrates the purge port is disconnected when the sample port and the sensor port are connected for the detection of the pressure in the exhaust pipe.

FIG. 7 illustrates the sample port is connected to the purge port.

FIG. 8 illustrates the pressure sensor activates the automation control system to disconnect the sensor port.

FIG. 9 illustrates the alarm times before the introduction of the three-way valve and after the introduction of the three-way valve for 13 consecutive months.

### DETAILED DESCRIPTION

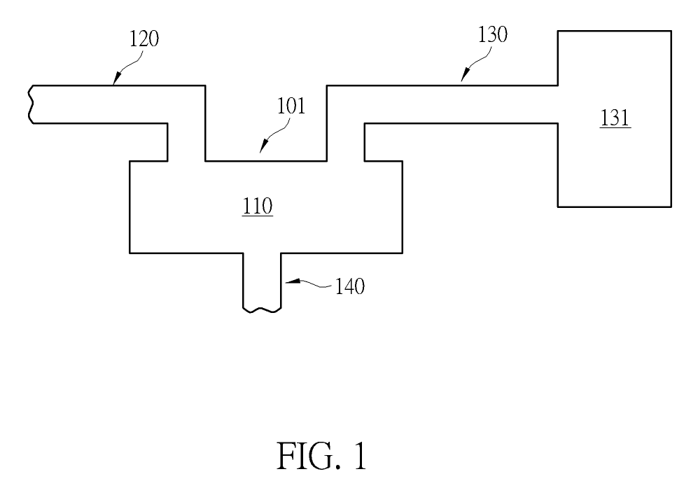

The present invention in a first aspect provides a three-way valve. FIG. 1 illustrates a first example of the three-way valve of the present invention. Please refer to FIG. 1. The three-way valve 101 of the present invention includes a valve joint 110, a sample port 120, a sensor port 130 and a purge port 140. The three-way valve may be controlled automatically or manually. For example, the three-way valve 101 may be an automatic electro-magnetic valve or a manual electro-magnetic valve with operational voltage between DC12-24V. The three-way valve may go with ¼ inch diameter pipes made of polybutylene terephthalate (PBT) with a pressure range 0.1˜2 kpa. The valve SMC V100-6-0AQ01804 may be used as the three-way valve 101.

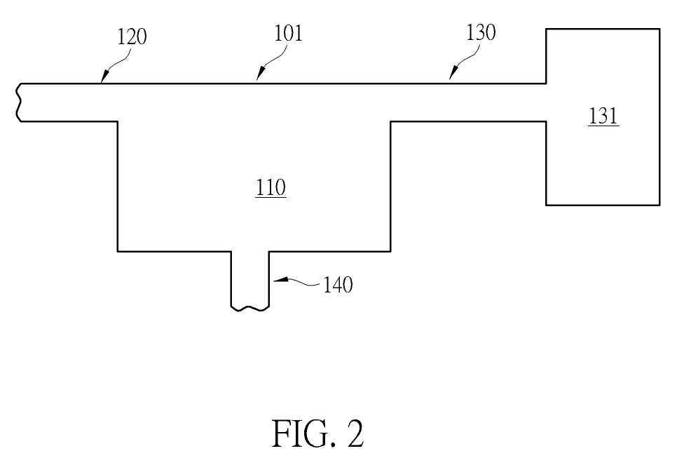

The three-way valve 101 has three ports, namely the sample port 120, the sensor port 130 and the purge port 140, and has the valve joint 110. The valve joint 110 extends in 3 directions so each port is individually and directly connected to the valve joint 110 to form a specific shape, for instance, a T-shape or a Y-shape but it is not limited to these shapes. The valve joint 110 is in charge of the connection among the sample port 120, the sensor port 130 and the purge port 140. FIG. 1 illustrates a first example of the three-way valve in a Y-shape. FIG. 2 illustrates a second example of the three-way valve in a T-shape.

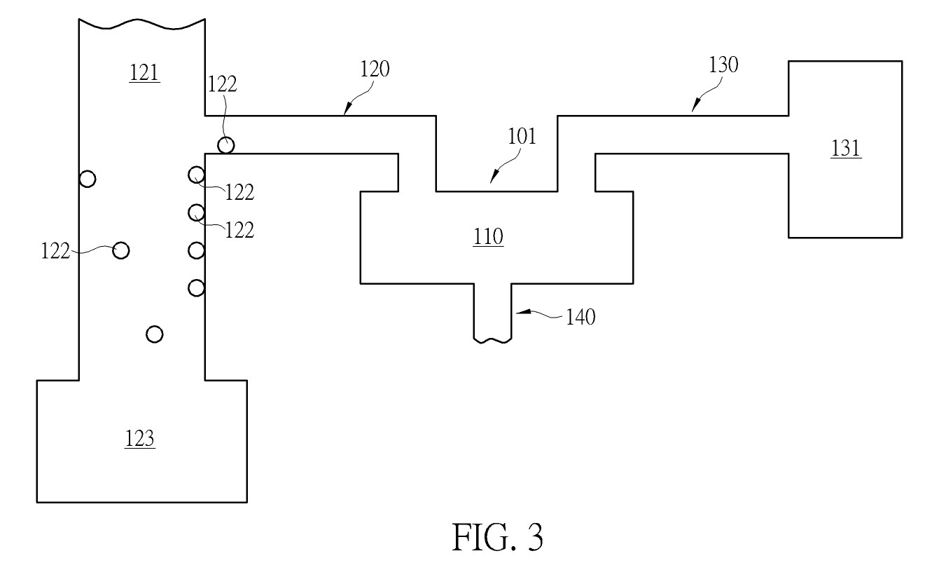

FIG. 3 illustrates the three-way valve of the present invention further connected to an exhaust pipe. As shown in FIG. 3, one end of the sample port 120 is directly connected to the valve joint 110 and the other end of the sample port 120 is directly connected to an exhaust pipe 121. The sample port 120 may serve as a dual port. In other words, the sample port 120 may optionally serve as an inlet or as an outlet.

The exhaust pipe 121 is an exhaust line to discharge the waste from a wet etching chamber 123. The waste may include a wet etching reagent from a wet etching procedure. For example, the waste in the exhaust pipe 121 may be HF, NH₃, isopropanol, H₃PO₄, H₂O₂, H₂SO₄, BOE (Buffer Oxide Etch, containing water) or the combination thereof. These chemicals tend to form liquids 122 in the exhaust pipe 121, particularly in the vicinity of the sample port 120. The wet etching chamber 123 may be an LAM DV-P Chamber.

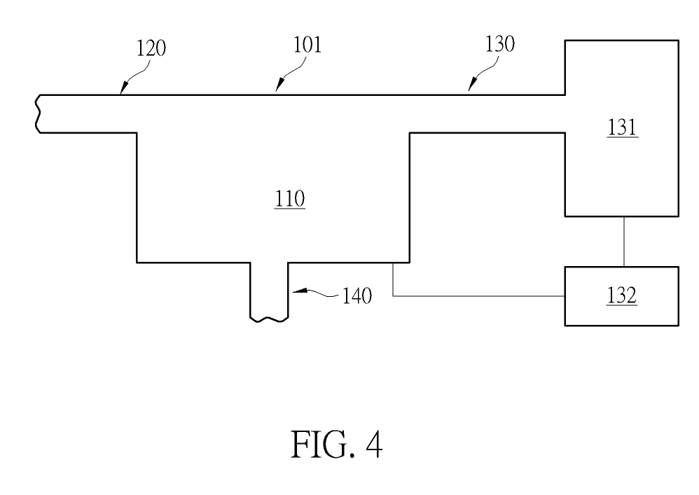

One end of the sensor port 130 is also directly connected to the valve joint 110. The other end of the sensor port 130 is directly connected to a pressure sensor 131. The pressure sensor 131 may have operational voltage between DC12-24V, MAX current of 16 mA, and go with ¼ inch diameter pipes made of polybutylene terephthalate (PBT) with a pressure range 0.1˜5 kpa for the detection of the pressure in the exhaust pipe 121. When the three-way valve 101 is controlled automatically, the three-way valve 101 may be controlled by an automation control system 132 which is electrically connected to the pressure sensor 131, as shown in FIG. 4. The liquids 122 may make the pressure sensor 131 fail to detect accurately.

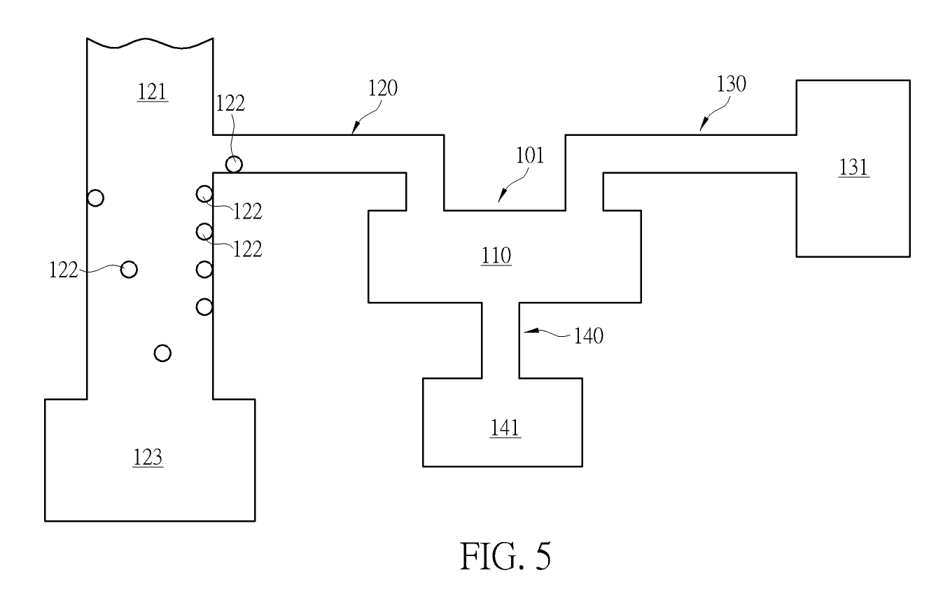

One end of the purge port 140 is directly connected to the valve joint 110, too, and the other end of the purge port 140 is directly connected to a purge gas source 141, as shown in FIG. 5, so the purge port 140 may selectively provide the sample port 120 with a purge gas 142 when the sensor port 130 is not in use.

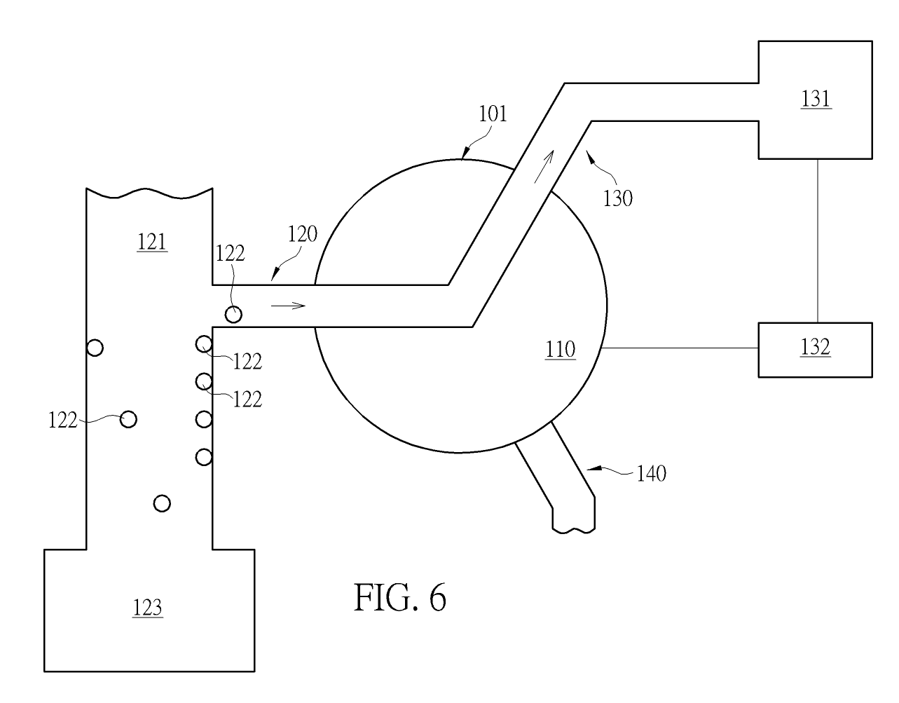

The purge gas source 141 for instance maybe CDA (compress dry air) or a nitrogen source but the purge gas source 141 is not limited to these. When the sample port 120 is connected to the sensor port 130 through the valve joint 110, the purge port 140 is temporarily disconnected. In this mode, the sample port 120 serves as an inlet of the pressure in the exhaust pipe 121 when the pressure sensor 131 is in use, as shown in FIG. 6.

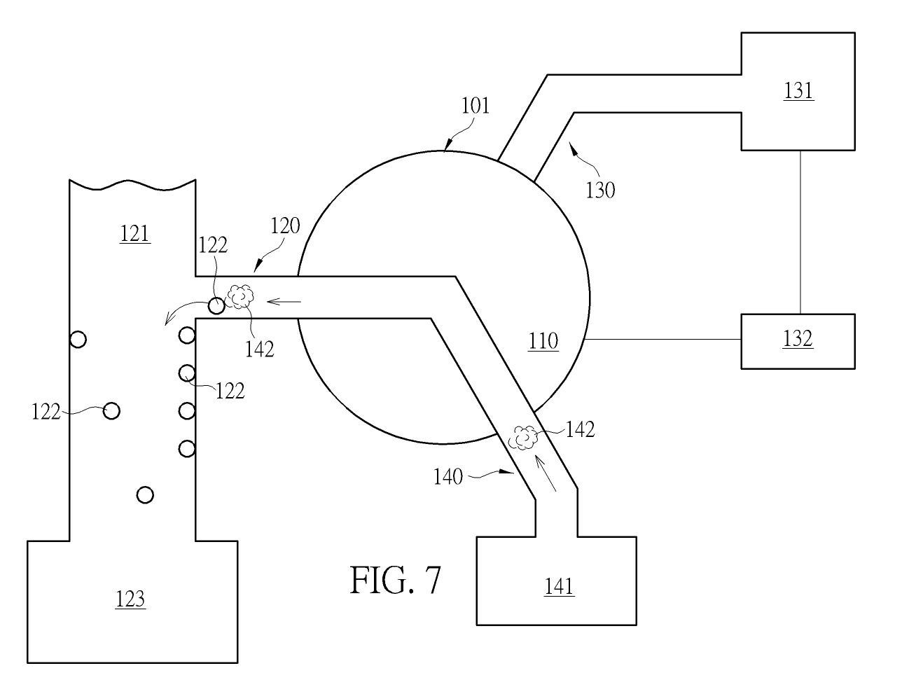

However, when the pressure sensor 131 detects that the etching chamber 123 is idle, the pressure sensor 131 then activates the automation control system 132 to disconnect the sensor port 130 so the sample port 120 is connected to the purge port 140, as shown in FIG. 7. In this mode, the purge port 140 serves as an inlet of the purge gas 142 to purge possible liquids 122 of wet etching reagents in the vicinity of the sample port 120 or in the exhaust pipe 121 when the sensor port 130 is temporarily disconnected so the sample port 120 serves as an outlet of the purge gas 142. This helps keep the pressure sensor 131 in good condition for the accurate detection of the exhaust pressure in the exhaust pipe 121 without interfering the uptime of the etching system. Also the automatic control helps keep the human resource involved to a minimum. For example, the purge port 140 may provide the sample port 120 with a purge gas 142 at a pressure of 0.83 hpa for 1 minute.

The present invention in a second aspect provides the use of the above-mentioned three-way valve 101. First, the above-mentioned three-way valve 101 is provided. Please refer to FIG. 1 to FIG. 5 and the above descriptions for details. Second, as shown in FIG. 6, the purge port 140 is disconnected when the sample port 120 and the sensor port 130 are connected for the detection of the pressure in the exhaust pipe 121.

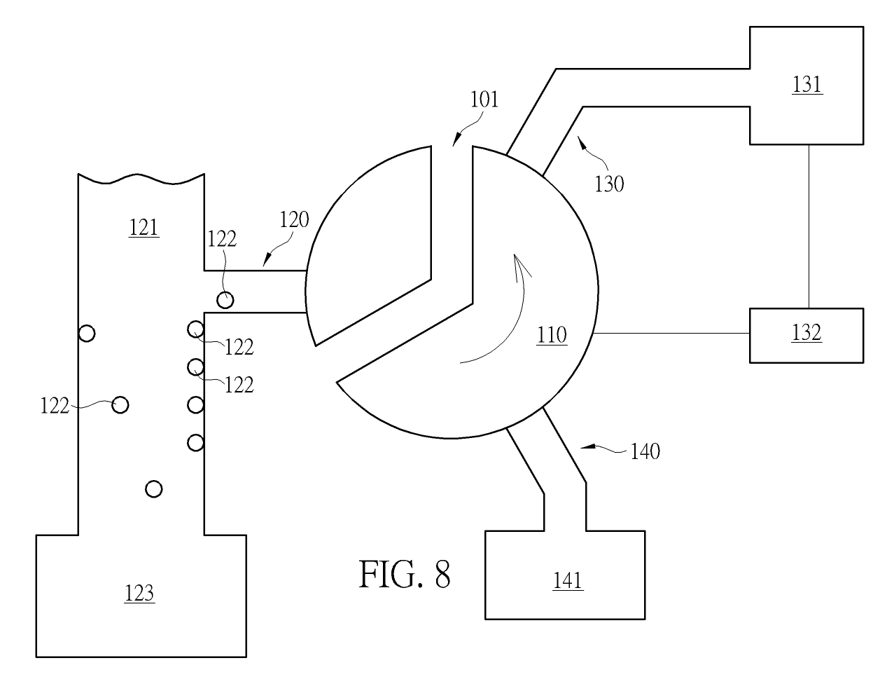

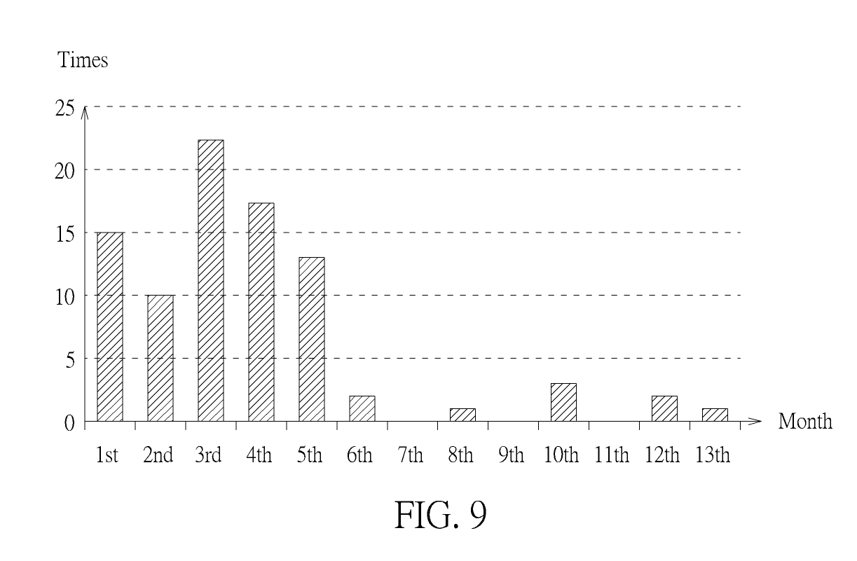

Then, the pressure sensor 131 detects that the etching chamber 123 is idle. When the wet etching chamber 123 is idle and the sensor port 130 is not in use, the pressure sensor 131 accordingly activates the automation control system 132 to disconnect the sensor port 130, as shown in FIG. 8, so the sample port 120 is connected to the purge port 140, as shown in FIG. 7. Because the sample port 120 is connected to the purge port 140, the purge port 140 is able to provide the sample port 120 with the purge gas 142. In this mode, the purge port 140 serves as an inlet of the purge gas 142 to purge possible liquids 122 of wet etching reagents in the vicinity of the sample port 120 or in the exhaust pipe 121 when the sensor port 130 is temporarily disconnected so the sample port 120 serves as an outlet of the purge gas 142. This helps keep the pressure sensor 131 in good condition for the detection of the pressure in the exhaust pipe 121 without interfering the uptime of the etching system. Also the automatic control helps keep the human resource involved to a minimum. Optionally, the switch of the sample port 120, the sensor port 130 and the purge port 140 or the activation of the purge gas 142 may be controlled manually. FIG. 9 illustrates the exhaust alarm times before the introduction of the three-way valve and after the introduction of the three-way valve for 13 consecutive months. The three-way valve was introduced in the 6^{th} month. It is clear that the exhaust alarm times were highly reduced after the introduction of the three-way valve so the use of the three-way valve of the present invention greatly reduces the risk to scrap the wafers kept in the etching chamber.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three-way valve, comprising:
a valve joint;
a sample port acting as a dual port and directly connected to said valve joint;
a sensor port directly connected to said valve joint; and
a purge port directly connected to said valve joint to selectively provide said sample port with a purge gas when said sensor port is disconnected.

2. The three-way valve of claim 1, wherein said three-way valve is an electro-magnetic valve.

3. The three-way valve of claim 1, wherein said sample port is connected to an exhaust pipe comprising a wet etching reagent.

4. The three-way valve of claim 1, wherein said sensor port is connected to a pressure sensor.

5. The three-way valve of claim 4, wherein said sample port is an inlet when said pressure sensor is in use.

6. The three-way valve of claim 1, wherein said sample port is an outlet of said purge gas when said purge port provides said purge gas.

7. The three-way valve of claim 3, wherein said purge port is an inlet to provide said purge gas to purge said wet etching reagent in said exhaust pipe.

8. The three-way valve of claim 4, wherein said three-way valve is controlled by an automation control system which is electrically connected to said pressure sensor.

9. The three-way valve of claim 1, wherein said three-way valve is controlled manually.

10. The three-way valve of claim 1, wherein said sensor port is disconnected when said purge port provide said sample port with a purge gas.

11. A method to use a three-way valve, comprising:
providing a three-way valve of claim 1;
disconnecting said purge port when said sample port and said sensor port are connected; and
disconnecting said sensor port when said sample port and said purge port are connected for said purge port to provide said sample port with said purge gas.

12. The method to use a three-way valve of claim 11, wherein said sample port is connected to an exhaust pipe comprising a wet etching reagent.

13. The method to use a three-way valve of claim 12, wherein said sensor port is connected to a pressure sensor for the detection of said exhaust pipe when said sample port and said sensor port are connected.

14. The method to use a three-way valve of claim 13, wherein said sample port serves as an inlet.

15. The method to use a three-way valve of claim 11, wherein said sample port serves as an outlet of said purge gas when said purge port provides said purge gas.

16. The method to use a three-way valve of claim 12, wherein said purge port is an inlet of said purge gas to purge said wet etching reagent in said exhaust pipe.

17. The method to use a three-way valve of claim 13, wherein said three-way valve is controlled by an automation control system which is electrically connected to said pressure sensor.

18. The method to use a three-way valve of claim 11, wherein said three-way valve is controlled manually.
